(19) United States
(12) Patent Application Publication
(10) Pub. No.: US 2017/0180293 A1
(43) Pub. Date: Jun. 22, 2017

(54) CONTEXTUAL TEMPORAL SYNCHRONIZATION MARKERS

(71) Applicant: INTERNATIONAL BUSINESS MACHINES CORPORATION, Armonk, NY (US)

(72) Inventor: Adam H. E. Eberbach, Melbourne (AU)

(21) Appl. No.: 14/972,516

(22) Filed: Dec. 17, 2015

(51) Int. Cl. H04L 12/58

(52) U.S. Cl. CPC H04L 51/16; H04L 51/32; H04L 51/20; H04L 51/36

(57) ABSTRACT

Embodiments include method, systems and computer program products for contextual temporal synchronization markers. In some embodiments, a client application of a user device may be initiated to display messages of a data feed. Data from a sensor associated with the user device may be obtained. A current position in the data feed may be obtained. A contextual stream may be generated using the data from the sensor and the current position in the data feed. The contextual stream may be stored.

### BACKGROUND

The present disclosure relates to methods, systems and computer program products for contextual temporal synchronization markers.

Data feeds may be composed of information obtained from different sources. For example, social networks may present information, such as messages, from people, groups, companies or the like. Typically, such messages are displayed in reverse chronological order. Depending on the user's interest and contacts, the timeline may be filled with numerous messages that are appended to the timeline throughout the day. In some scenarios, users may wish to locate a specific message. However, with the addition of the new messages throughout the day and the availability of the messages only through the timeline, it may be difficult to locate the specific message. For example, a user may find themselves wishing they could find a link that was in the timeline when viewed on a particular device or in a particular location but finding any content can be very hard when hundreds if not thousands of items are appearing every day.

### SUMMARY

In accordance with an embodiment, a method for digital message delivery using ad-hoc distributed device networking is provided. The method may include initiating a client application of a user device to display messages of a data feed; obtaining data from a sensor associated with the user device; obtaining a current position in the data feed; generating a contextual stream using the data from the sensor and the current position in the data feed; and storing the contextual stream.

In another embodiment, a computer program product may comprise a non-transitory storage medium readable by a processing circuit and storing instructions for execution by the processing circuit for performing a method that may include initiating a client application of a user device to display messages of a data feed; obtaining data from a sensor associated with the user device; obtaining a current position in the data feed; generating a contextual stream using the data from the sensor and the current position in the data feed; and storing the contextual stream.

In another embodiment, a system for optimizing persistency using hybrid memory may include a processor in communication with one or more types of memory. The processor may be configured to initiate a client application of a user device to display messages of a data feed; obtain data from a sensor associated with the user device; obtain a current position in the data feed; generate a contextual stream using the data from the sensor and the current position in the data feed; and store the contextual stream.

### BRIEF DESCRIPTION OF THE DRAWINGS

The forgoing and other features, and advantages of the disclosure are apparent from the following detailed description taken in conjunction with the accompanying drawings in which:

FIG. 1 is a block diagram illustrating one example of a processing system for practice of the teachings herein;

FIG. 2 is a block diagram illustrating a computing system in accordance with an exemplary embodiment;

FIG. 3 is a flow diagram of a method for generating contextual temporal synchronization markers in accordance with an exemplary embodiment; and

FIG. 4 is a flow diagram of a method for retrieving contextual temporal synchronization markers in accordance with an exemplary embodiment.

### DETAILED DESCRIPTION

In accordance with exemplary embodiments of the disclosure, methods, systems and computer program products for contextual temporal synchronization makers are provided. The methods and systems described herein are directed to generating and presenting contextual streams of data to aid users in locating messages in data streams. In some embodiments, a user may be provided with position markers as their context, such as environmental context, changes. At the start of each viewing session, a client application may record a position in the timeline and a context. A context may include the name of the application or data feed, a unique universal identifier (UUID) a time, and/or a place. A user may then be able to browse these markers when trying to find a specific message in a data feed. Using a “favorite” or “like” marker, as provided by some social networks, may not be appropriate as either mechanisms may constitute an explicit approval of the item, which may not be the intent, and a user using “favorite” or “like” for this purpose may accumulate so many such items that they become as difficult to locate as if not marked at all.

At the start of each viewing session (i.e. opening of a client application), the client application may gather data and generate a context stream. Context may include, but is not be limited to, geographic location, time of day, weather conditions, movement condition (e.g., speed and direction of travel), light conditions, and/or unique identifier. Later, the user may locate a specific message by utilizing the generated context stream. The context may be displayed by the client application and allow the user to peruse the range of messages captured and associated with a specific context.

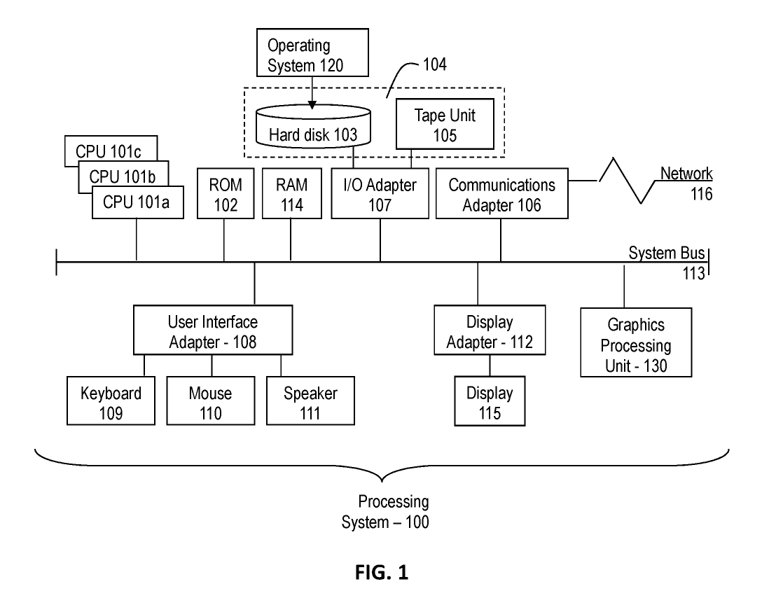

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics-processing unit 130. Graphics processing unit 130 is a specialized electronic circuit designed to manipulate and alter memory to accelerate the creation of images in a frame buffer intended for output to a display. In general, graphics-processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system such as the AIX® operating system from IBM Corporation to coordinate the functions of the various components shown in FIG. 1.

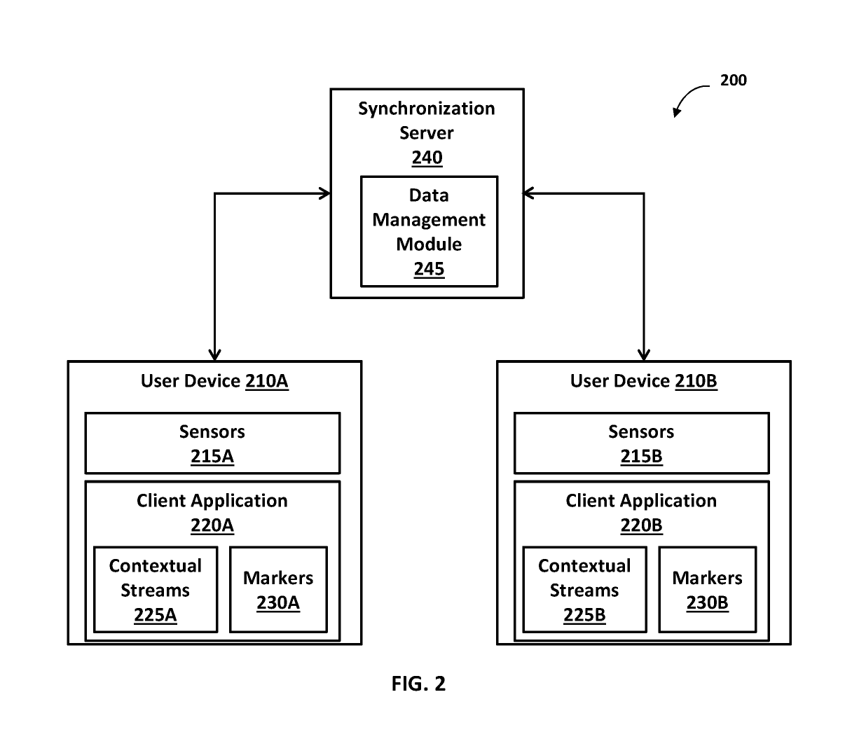

Referring now to FIG. 2, a computing system 200 in accordance with an embodiment is illustrated. As illustrated, the computing system 200 may include, but is not limited to, user device(s) 210A, 210B (collectively 210) and/or a synchronization server 240. A user device 210A may include one or more sensors 215A and a client application 220A. The client application 220A may generate, store, and retrieve contextual streams 225A and/or markers 230A. A synchronization server 240 may include a data management module 245.

In some embodiments, the user device 210 may maybe any type of portable device that has the capability to connect to a network, such as using Wi-Fi or cellular technologies. Examples of a user device 210 may include smartphones, tablets, laptops, and the like. User devices 210 may include one or more sensors 215A, 215B (also referred singularly as 215). Examples of sensors may include microphone, camera, accelerometer, gyroscope, GPS sensors, antenna, and the like. Sensors may be used to collect data, such as location, lighting conditions, direction and speed of travel, ambient noise, and the like. The data may be transmitted to the client application 220A.

The client application 220A may include computer-readable instructions that in response to execution by the processor(s) 101 cause operations to be performed including displaying one or more data feeds to the user. The client application 220A may also use the data from the sensors to generate one or more contextual streams 225A, 225B (also referred singularly as 225). The client application 220A may retrieve previously generated contextual streams 225A from a local data store or from a remote location, such as a synchronization server 240. In some embodiments, the client application 220A may facilitate presentation of the contextual streams 225A to a user of the user device 210A. Additionally, the client application 220A may receive an indication from the user of the user device 210 to create a marker 230A for a specific message of the data feed so that the user may easier return to the message at a later time. The client application 220A may transmit generated contextual streams 225A and markers 230 to a synchronization server 240 to enable other user devices 210B operated by the user to retrieve them and display them to the user when they are operating another user device 210A.

In some embodiments, the synchronization server 240 may include a data management module 245. The data management module 245 may include computer-readable instructions that in response to execution by the processor(s) 101 cause operations to be performed including receiving contextual streams 225A, 225B and/or markers 230A, 230B from different user devices 210A, 210B operated by a user. The synchronization server 240 may receive and store the information as back-up or may coordinate transmitting information received from one user device 210A to another user device 210B, which may enable a user continuity and synchronization across devices.

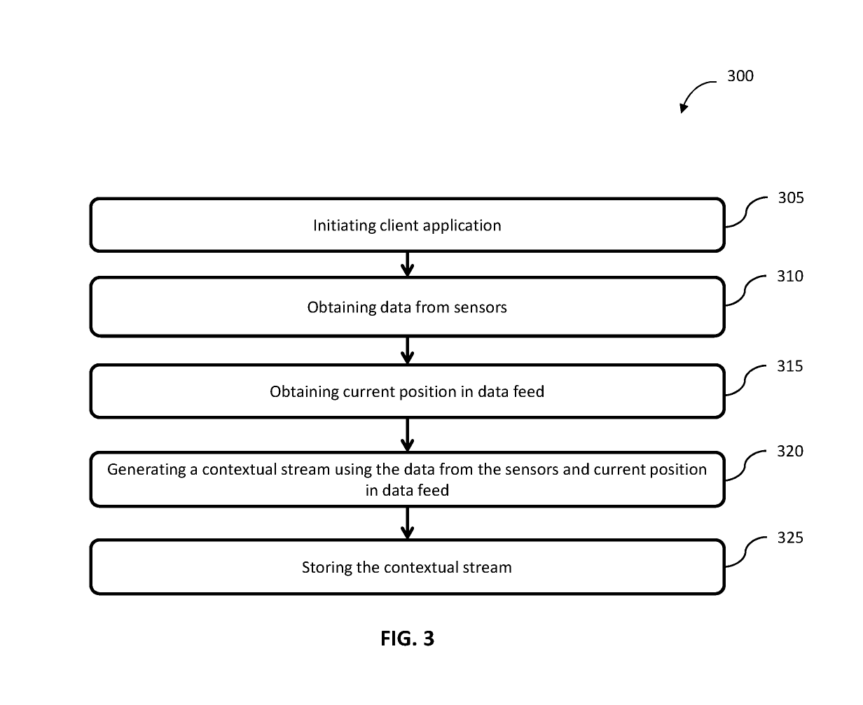

FIG. 3 is a flow diagram of a method 300 for generating contextual temporal synchronization markers in accordance with an exemplary embodiment. At block 305, a client application 220A on a user device 210A may be initiated. The client application 220A may display messages of a data feed. In some embodiments, the data feed may include messages from two or more social networks (e.g., Facebook™, Twitter™, etc.).

At block 310, the client application 220A may obtain data from one or more sensors 215A associated with the user device 210A. Examples of a sensor 215A may include, but are not limited to, a global positioning system (GPS) sensor, microphone, camera, accelerometer, gyroscope, or antenna.

At block 315, the client application 220A may obtain a current position in the data feed. In some embodiments, the client application 220A may maintain a pointer that indicates a current position (e.g., message of the data feed) that the user has viewed.

At block 320, the client application 220A may generate a contextual stream 225A using the data from the sensor 215A and the current position in the data feed. For example, the client application 220A may associate the data from the sensors 215A with a message identifier of the current position in the data feed. In some embodiments, a contextual stream may include a continuum of data from the sensor 215A associated with corresponding messages from the data feed. A contextual stream 225A may consist of a map of locations traveled by the user, where different locations are associated with different position in the data stream the user may have viewed. A contextual stream 225A may include a continuum of different types of lighting (e.g., indoor, outdoor, bright, ambient, etc.) associated with different positions in the data stream the user may have viewed. Another example of a contextual data stream 225A may include a continuum of different types of noise (e.g., quiet, indoor, outdoor, etc.) where different levels of noise may be associated different positions in the data stream the user may have viewed.

Additionally, in some embodiments, the client application 220A may associate markers 230A with specific positions in the contextual stream 225A. The client application 220A may receive an indication to mark a message of the data feed from a user. The client application 220A may generate a marker 230A (e.g., marker pointer) associated with the message of the data feed. The client application 220A may associate the marker 230A with the contextual stream 225A. In some embodiments, the marker 230A may be indicated by visual element, such as an icon, color, number, or the like, to identify the marker 230A in the contextual stream 225A.

At block 325, the client application 220A may store the contextual stream 225A. In some embodiments, the contextual stream 225A may be stored locally on the user device 210A. In some embodiments, the contextual stream 225A may be transmitted to a server, such as the synchronization server 240. The synchronization server 240 may provide the contextual stream 225A to other user devices 210 associated with the user.

In some embodiments, a user may wish to locate a previously viewed message in a data feed but may not remember the location of the specific message. The user may indicate, via the client application 220A, they wish to retrieve a contextual stream 225A. The client application 220A may retrieve a previously generated contextual stream 225A. The retrieved contextual stream 225A may be displayed to the user by the client application 220A. The client application 220A may receive an indication of a position in the contextual stream 225A via an interface displayed to the user of the user device 210A. The client application 220A may obtain a position in the data feed corresponding to the position in the contextual stream 225 received from the user. The client application 220A may display the message of the data feed corresponding to the indicate position in the contextual stream 225A to the user via the client application 220A.

In some embodiments, contextual streams 225 and/or markers 230 may be expunged from the user device 210 and/or synchronization server 240 periodically at predetermined intervals. In some embodiments, the intervals may be specified by the user. In some embodiments, the contextual streams 225 and/or markers 230 may be expunged upon an indication received from a user.

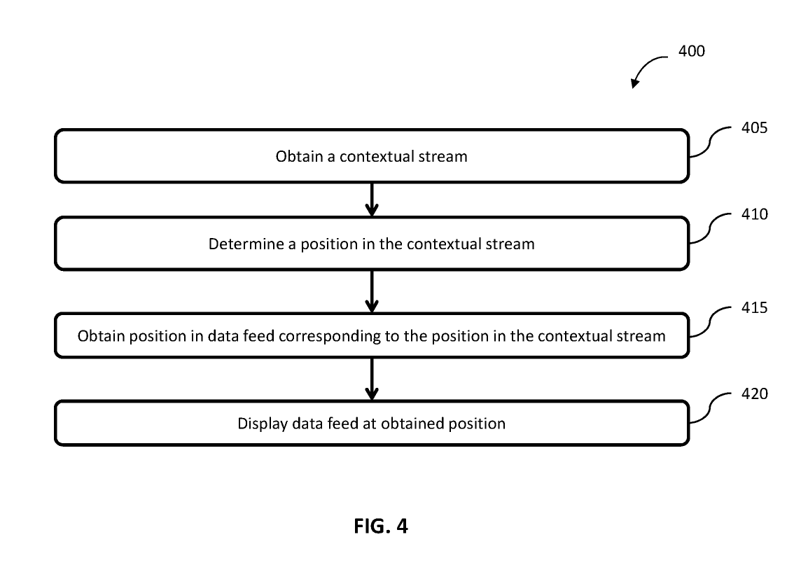

FIG. 4 is a flow diagram of a method 400 for retrieving contextual temporal synchronization markers in accordance with an exemplary embodiment. At block 405, a user device 210A may obtain a contextual stream 225B associated with a second user device 210B. In some embodiments, the client application 220A may request a contextual stream 225B generated by another user device 210B by transmitting a request to a synchronization server 240. The client application 220A may receive the contextual stream 225B from the data management module 245 and may display the contextual stream 225B on the user device 210A.

At block 410, the client application 220A may determine a position in the contextual stream 225B. In some embodiments, the client application 220A may receive an indication of a position in the contextual stream 225B via an interface presented to the user by the client application 220A.

At block 415, the client application 220A may use the position in the contextual stream 225B to obtain a position in the data feed corresponding to the indicated position in the contextual stream 225B. In some embodiments, the client application 220A may traverse the contextual stream 225B to the position indicated at block 415 and identify a message of the data feed at the position in the contextual stream 225B.

At block 420, the client application 220A may display the message of the data feed corresponding to the indicated position of the contextual stream 225B.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method comprising:
initiating a client application of a user device to display messages of a data feed;
obtaining data from a sensor associated with the user device;
generating a contextual stream using the data from the sensor;
receiving an indication to mark a message of the data feed;
determining a position of the message in the data feed;
associating a marker with the position of the message in the data feed;
determining a position in the contextual stream, the position corresponding to data from the sensor captured over a time period that includes a time at which the message in the data feed is received;
associating the marker with the position in the contextual stream;
storing the contextual stream;
receiving a user selection of the position in the contextual stream;
determining, based at least in part on the marker, that the position of the message in the data feed corresponds to the position in the contextual stream; and
displaying the message via a user interface of the client application.

2. (canceled)

3. The computer-implemented method of claim 1, wherein the data feed comprises messages from two or more social networks.

4. (canceled)

5. The computer-implemented method of claim 1, wherein storing the contextual stream comprises:
transmitting the contextual stream to a server.

6. The computer-implemented method of claim 1, wherein the user device is a first user device, the message is a first message, and the contextual stream is a first contextual stream, the method further comprising:
requesting a second contextual stream associated with a second user device from a server;
receiving the second contextual stream;
displaying the second contextual stream by the client application;
receiving an indication of a first position in the second contextual stream;
obtaining a second position in the data feed corresponding to the first position in the second contextual stream; and
displaying a second message of the data feed corresponding to the second position in the data feed.

7. The computer-implemented method of claim 1, wherein the sensor is one of a global positioning system (GPS) sensor, microphone, camera, accelerometer, gyroscope or antenna.

8. A computer program product comprising a non-transitory storage medium readable by a processing circuit and storing instructions for execution by the processing circuit for performing a method comprising:
initiating a client application of a user device to display messages of a data feed;
obtaining data from a sensor associated with the user device;
generating a contextual stream using the data from the sensor;
receiving an indication to mark a message of the data feed;
determining a position of the message in the data feed;
associating a marker with the position of the message in the data feed;
determining a position in the contextual stream, the position corresponding to data from the sensor captured over a time period that includes a time at which the message in the data feed is received;
associating the marker with the position in the contextual stream;
storing the contextual stream;
receiving a user selection of the position in the contextual stream;
determining, based at least in part on the marker, that the position of the message in the data feed corresponds to the position in the contextual stream; and
displaying the message via a user interface of the client application.

9. (canceled)

10. The computer program product of claim 8, wherein the data feed comprises messages from two or more social networks.

11. (canceled)

12. The computer program product of claim 8, wherein storing the contextual stream comprises:
transmitting the contextual stream to a server.

13. The computer program product of claim 8, wherein the user device is a first user device, the message is a first message, and the contextual stream is a first contextual stream, the method further comprising:
requesting a second contextual stream associated with a second user device from a server;
receiving the second contextual stream;
displaying the second contextual stream by the client application;
receiving an indication of a first position in the second contextual stream;
obtaining a second position in the data feed corresponding to the first position in the second contextual stream; and
displaying a second message of the data feed corresponding to the second position in the data feed.

14. The computer program product of claim 8, wherein the sensor is one of a global positioning system (GPS) sensor, microphone, camera, accelerometer, gyroscope or antenna.

15. A system, comprising:
a processor in communication with one or more types of memory, the processor configured to:
initiate a client application of a user device to display messages of a data feed;
obtain data from a sensor associated with the user device;
generate a contextual stream using the data from the sensor;
receive an indication to mark a message of the data feed;
determine a position of the message in the data feed;
associate a marker with the position of the message in the data feed;
determine a position in the contextual stream, the position corresponding to data from the sensor captured over a time period that includes a time at which the message in the data feed is received;
associate the marker with the position in the contextual stream;
store the contextual stream;
receive a user selection of the position in the contextual stream;
determine, based at least in part on the marker, that the position of the message in the data feed corresponds to the position in the contextual stream; and
display the message via a user interface of the client application.

16. (canceled)

17. The system of claim 15, wherein the data feed comprises messages from two or more social networks.

18. (canceled)

19. The system of claim 15, wherein, to store the contextual stream, the processor is further configured to:
transmit the contextual stream to a server.

20. The system of claim 15, wherein the user device is a first user device, the message is a first message, and the contextual stream is a first contextual stream, and wherein the processor is further configured to:
request a second contextual stream associated with a second user device from a server;
receive the second contextual stream;
display the second contextual stream by the client application;
receive an indication of a first position in the second contextual stream;
obtain a second position in the data feed corresponding to the first position in the second contextual stream; and
display a second message of the data feed corresponding to the second position in the data feed.

21. The computer-implemented method of claim 1, wherein the data from the sensor corresponding to the position in the contextual stream comprises data indicative of at least one of a location of the user device, an ambient noise level, a speed of the user device, or an ambient light level.
